(19) United States
(12) Patent Application Publication
(10) Pub. No.: US 2025/0168569 A1
(43) Pub. Date: May 22, 2025

(54) SOUND PRODUCTION MODULE AND TERMINAL DEVICE

(71) Applicant: GOERTEK INC., Weifang, Shandong (CN)

(72) Inventors: Xiaodong CAI, Weifang, Shandong (CN); Song LIU, Weifang, Shandong (CN); Xianzhong LANG, Weifang, Shandong (CN); Chengfei ZHANG, Weifang, Shandong (CN); Chunfa LIU, Weifang, Shandong (CN)

(21) Appl. No.: 18/839,466

(22) PCT Filed: Mar. 9, 2023
(86) PCT No.: PCT/CN2023/080535

§ 371 Date: Aug. 19, 2024

(30) Foreign Application Priority Data
Apr. 2, 2022 (CN) 202210346962.7

(51) Int. Cl. H04R 9/02; H04M 1/03; H04R 9/06

(52) U.S. Cl. CPC H04R 9/025; H04M 1/03; H04R 9/06; H04R 2400/11; H04R 2499/11

(57) ABSTRACT

A sound production module and a terminal device are disclosed. The sound production module includes a sound production unit and an expansion cavity, the sound production unit includes a magnetic circuit system, a receiver unit including a first diaphragm and a speaker unit opposite to the receiver unit and including a second diaphragm. Vibration systems of the receiver unit and the speaker unit are on two opposite sides of the magnetic circuit system. A first rear cavity is formed between the first diaphragm and the magnetic circuit system. A second rear cavity is formed between the second diaphragm and the magnetic circuit system. The first rear cavity is separated from the second rear cavity and the expansion cavity. The receiver unit is provided with a communication hole for communicating the first rear cavity with a space outside the sound production module and not communicated with the expansion cavity.

### TECHNICAL FIELD

The present disclosure relates to a technical field of electroacoustic energy conversion, and more particularly, to a sound production module and a terminal device.

### DESCRIPTION OF RELATED ART

At present, in order to allow electronic products in the related art (such as mobile phones) have a better stereo effect when they are in a speaker mode, and have a better privacy protection effect when they are in a receiver mode, generally, in audio systems of the electronic products, a speaker module and a receiver unit which are stacked are used (defined as a first solution) or a double-sided sound production unit is directly used (defined as a second solution), so as to emit two sound waves with the same phase, the two sound waves are stacked and enhanced to improve the stereo effect in the speaker mode, or to emit two sound waves with opposite phases, the two sound waves are cancelled and attenuated based on an acoustic dipole effect to improve the privacy protection effect in the receiver mode.

However, there are still many defects when using the above-mentioned first and second solutions. Specifically, in the first solution, the speaker module and the receiver unit are two independent devices, and in this case, the speaker module and the receiver unit are required to be stacked back-to-back when they are installed in a casing of a terminal device. However, the back-to-back stacking arrangement will inevitably make the two devices required to occupy a very large mounting space in a stacking direction when installed, and the thickness of the terminal device is generally set relatively thin, makes it difficult to install the stacked speaker module and receiver unit as a whole in the casing of the terminal device. At the same time, the two independent devices will also make the number of overall parts relatively large, resulting in an increase in the overall manufacturing cost of the terminal device. In the second solution, two vibration systems in the double-sided sound production unit are generally arranged to share one acoustic rear cavity. At this time, when the two vibration systems are operated separately, the shared acoustic rear cavity will cause the airflows to interfere with each other during flow, thus affecting the vibration state of each vibration system, and causing a series of problems such as increased nonlinear distortion and swing vibration and abnormal sound, which affects the final sound production effect. In addition, the rear cavity shared by double-sided diaphragms is a closed rear cavity, which results in low-frequency intensity, and affecting the sound production effect of the sound production module.

### SUMMARY

A main purpose of the present disclosure is to provide a sound production module, aiming to improve the sound production effect of the sound production module.

In order to achieve the above purpose, the present disclosure provides a sound production module including a sound production unit and an expansion cavity, and the sound production unit includes a receiver unit and a speaker unit opposite to the receiver unit,
wherein the sound production unit further includes a magnetic circuit system, a vibration system of the receiver unit and a vibration system of the speaker unit are provided on two opposite sides of the magnetic circuit system,
wherein the receiver unit includes a first diaphragm, and a first rear cavity is formed between the first diaphragm and the magnetic circuit system. The speaker unit includes a second diaphragm, and a second rear cavity is formed between the second diaphragm and the magnetic circuit system. The first rear cavity and the second rear cavity are separated from each other, and the first rear cavity and the expansion cavity are separated from each other. The receiver unit is provided with a communication hole for communicating the first rear cavity with a space outside the sound production module, and the communication hole is not communicated with the expansion cavity.

In an embodiment of the present disclosure, a first frame is provided between the first diaphragm of the receiver unit and the magnetic circuit system, and the first frame is provided with the communication hole penetrating through a side wall of the first frame.

In an embodiment of the present disclosure, a surface of the first frame opposite to the first diaphragm has a groove, and the communication hole is formed between the surface of the first frame having the groove and the magnetic circuit system, and/or
a surface of the magnetic circuit system close to the first diaphragm protrudes outward to form the first frame or the first frame and the magnetic circuit system are separated structures.

In an embodiment of the present disclosure, the communication hole is provided on two opposite short axis sides of the first frame.

In an embodiment of the present disclosure, two communication holes spaced apart are provided on each short axis side of the first frame.

In an embodiment of the present disclosure, a reinforcing rib is protruded from an outer side wall of the first frame, and the reinforcing rib is located between the two communication holes on the same short axis side of the first frame.

In an embodiment of the present disclosure, a mounting boss is provided on a side of the magnetic circuit system facing the first diaphragm, the first frame is provided on the mounting boss, and the surface of the first frame having the groove contacts and forms the communication hole with a table surface of the mounting boss.

In an embodiment of the present disclosure, a mounting groove is formed on the table surface of the mounting boss, an inserting block protruding from the surface of the first frame having the groove is inserted into the mounting groove.

In an embodiment of the present disclosure, a mounting plane for mounting the first diaphragm is formed on a surface of the first frame opposite to the magnetic circuit system.

In an embodiment of the present disclosure, a mounting space is formed by a plurality of limit blocks spaced apart protruding from the mounting plane, the first diaphragm is fixed in the mounting space, and the limit blocks are hooked on an edge of the first diaphragm.

In an embodiment of the present disclosure, a first frame is provided between the first diaphragm of the receiver unit and the magnetic circuit system, a first groove is provided at a position of the magnetic circuit system corresponding to a side wall of the first frame, and the communication hole is formed between a surface of the magnetic circuit system having the first groove and the first frame, or
a first frame is provided between the first diaphragm of the receiver unit and the magnetic circuit system, the first frame has a second groove on a surface opposite to the first diaphragm, the magnetic circuit system has a third groove at a position corresponding to the first frame, and the communication hole is formed between the surface of the first frame having the second groove and a surface of the magnetic circuit system having the third groove.

In an embodiment of the present disclosure, the sound production unit further includes a front cover covered on the first diaphragm, an opening is disposed at a position of the front cover directly facing the first diaphragm, and the opening forms a first sound outlet channel, and/or
and/or, the magnetic circuit system has a center line extending along a width direction thereof, and the first frame is symmetrically arranged about the center line, and/or
a cross-sectional area of the communication hole is defined as S, which satisfies the following condition: 0.5 mm²≤S≤1.0 mm².

In an embodiment of the present disclosure, the sound production module further includes a fix housing for fixing the sound production unit, and the expansion cavity is formed between the fix housing and the sound production unit.

In an embodiment of the present disclosure, the sound production unit further includes a second frame disposed between the second diaphragm of the speaker unit and the magnetic circuit system, the second rear cavity is formed between the second diaphragm, the second frame and the magnetic circuit system, and the second rear cavity is communicated with the expansion cavity.

The present disclosure also provides a terminal device, including:
a casing having a mounting cavity formed therein;
a sound production module disposed in the mounting cavity, the first rear cavity of the sound production module is communicated with the mounting cavity through a communication hole,
wherein the sound production module includes:
a sound production unit and an expansion cavity, and the sound production unit includes a receiver unit and a speaker unit disposed opposite to the receiver unit,
wherein the sound production unit further includes a magnetic circuit system, a vibration system of the receiver unit and a vibration system of the speaker unit are provided on two opposite sides of the magnetic circuit system,
wherein the receiver unit includes a first diaphragm, and a first rear cavity is formed between the first diaphragm and the magnetic circuit system, the speaker unit includes a second diaphragm, and a second rear cavity is formed between the second diaphragm and the magnetic circuit system, the first rear cavity and the second rear cavity are separated from each other, and the first rear cavity and the expansion cavity are separated from each other, the receiver unit is provided with a communication hole for communicating the first rear cavity with a space outside the sound production module, and the communication hole is not communicated with the expansion cavity.

According to the sound production module of the technical solution of the present disclosure, a speaker unit and a receiver unit are provided, so that the sound production module has dual functions of a speaker function and a receiver function by operating the speaker unit and the receiver unit, respectively. Moreover, since the receiver unit and the speaker unit share one magnetic circuit system, compared with simply back-to-back stacking of the receiver module and the speaker module, the sound production module in the present solution can reduce the number of magnet systems, which is beneficial to simplify the overall structure of the sound production module and reduce the overall thickness of the sound production module, thereby improving its subsequent convenience for installing on the terminal device. Meanwhile, on the basis that the receiver unit and the speaker unit share one magnetic circuit system, a first rear cavity may be formed by a first diaphragm of the receiver unit and the magnetic circuit system, and a second rear cavity separated from the first rear cavity may be formed by a second diaphragm of the speaker unit and the magnetic circuit system. At this time, since the first rear cavity in the receiver unit and the second rear cavity in the speaker unit are in a separated state, the first diaphragm in the receiver unit and the second diaphragm in the speaker unit vibrate only in the first rear cavity and the second rear cavity, respectively, and there will be no problem of airflow interference. This ensures that the receiver unit and the speaker unit can operate normally and stably, respectively, thereby improving the sound production effect of the sound production module. Further, the first rear cavity of the receiver unit may be communicated with the space outside the sound production module through a communication hole, thereby providing a sound-enhanced space for the first rear cavity of the receiver unit, effectively improving the low-frequency intensity, and further improving the sound production effect of the sound production module.

### BRIEF DESCRIPTION OF DRAWINGS

In order to more clearly illustrate the technical solutions in the embodiments of the present disclosure or the prior art, the drawings required to be used for the embodiments or the prior art will be briefly introduced in the following. Obviously, the drawings in the following description are merely some embodiments of the present disclosure, and for those of ordinary skill in the art, other drawings can also be obtained from the provided drawings without any creative effort.

FIG. 1 is a cross-sectional view of an embodiment of a terminal device of the present disclosure;

FIG. 2 is another cross-sectional view of an embodiment of a terminal device of the present disclosure;

FIG. 3 is a cross-sectional view of an embodiment of a sound production module of the present disclosure;

FIG. 4 is a partial schematic diagram of the sound production module in FIG. 3;

FIG. 5 is a partial exploded view of the sound production module in FIG. 4.

### REFERENCE NUMERALS

| Numeral | Name | Numeral | Name |
|---|---|---|---|
| 1000 | terminal device | 31 | first diaphragm |
| 100 | sound production | 33 | first voice coil |
| | module | 30a | first rear cavity |
| 10 | magnetic circuit | 50 | speaker unit |
| | system | 51 | second diaphragm |
| 10a | first magnetic gap | 53 | second voice coil |
| 10b | second magnetic gap | 50a | second rear cavity |
| 11 | first frame | 70 | front cover |
| 11a | communication hole | 71 | first sound outlet |
| 11b | inserting block | | channel |
| 11c | limit block | 90 | fix housing |
| 15 | mounting boss | 90a | expansion cavity |
| 15a | mounting groove | 300 | casing |
| 111 | reinforcing rib | 301 | mounting cavity |
| 13 | second frame | | |
| 30 | receiver unit | | |

The realization of the purpose, functional features and advantages of the present disclosure will be further explained in conjunction with embodiments and with reference to the accompanying drawings.

### DETAILED DESCRIPTIONS

Technical solutions of embodiments of the present disclosure will be clearly and completely described below with reference to the drawings in the embodiments of the present disclosure. Obviously, the described embodiments are only a part of the embodiments of the present disclosure, rather than all the embodiments. Based on the embodiments in the present disclosure, all other embodiments obtained by those of ordinary skill in the art without creative efforts shall fall within the protection scope of the present disclosure.

It should be noted that if the embodiments of the present disclosure involve directional indications, the directional indications are only used to explain the relative position relationship, movement status, etc. between the components under a certain specific posture, and if the specific posture changes, the directional indications will also change accordingly.

In addition, if there are descriptions involving “first”, “second”, etc. in the embodiments of the present disclosure, the descriptions of “first”, “second”, etc. are only used for descriptive purposes and cannot be understood as indicating or implying their relative importance or implicitly indicating the number of the indicated technical features. Therefore, the features defined as “first” or “second” may explicitly or implicitly include at least one of the features. In addition, the technical solutions between the various embodiments can be combined with each other, but it should be based on the fact that those skilled in the art in the art can achieve it. When the combination of technical solutions is contradictory or cannot be implemented, it should be deemed that such combination of technical solutions does not exist and is not within the protection scope of the present disclosure.

The present disclosure provides a sound production module 100, aiming at improving the sound production effect of the sound production module 100.

It will be understood that the sound production module 100 presented in the present disclosure may be applied to various types of small terminal devices 1000, such as mobile phone, tablet computer, television, monitor, laptop, digital photo frame, personal digital assistant (PDA), e-book reader, MP3 (Moving Picture Experts Group Audio Layer III) player, MP4 (Moving Picture Experts Group Audio Layer IV) player, wearable device, navigator, handheld game console, virtual reality device, augmented reality device, desktop speaker, etc. Also, the sound production module 100 presented in the present disclosure may be applied to various medium or large terminal devices 1000, which will not be described in detail here.

The specific structure of the sound production module 100 of the present disclosure is described below.

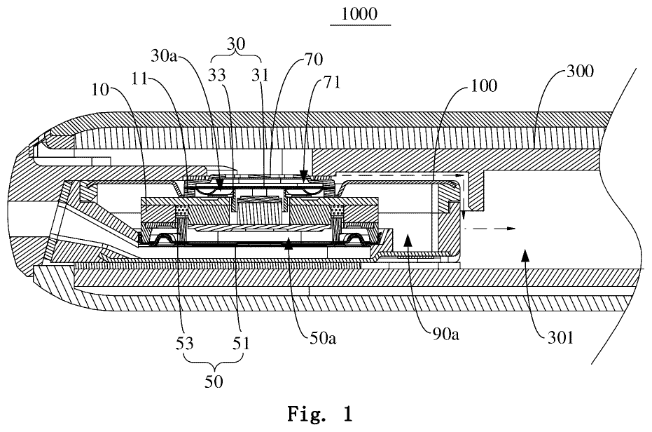

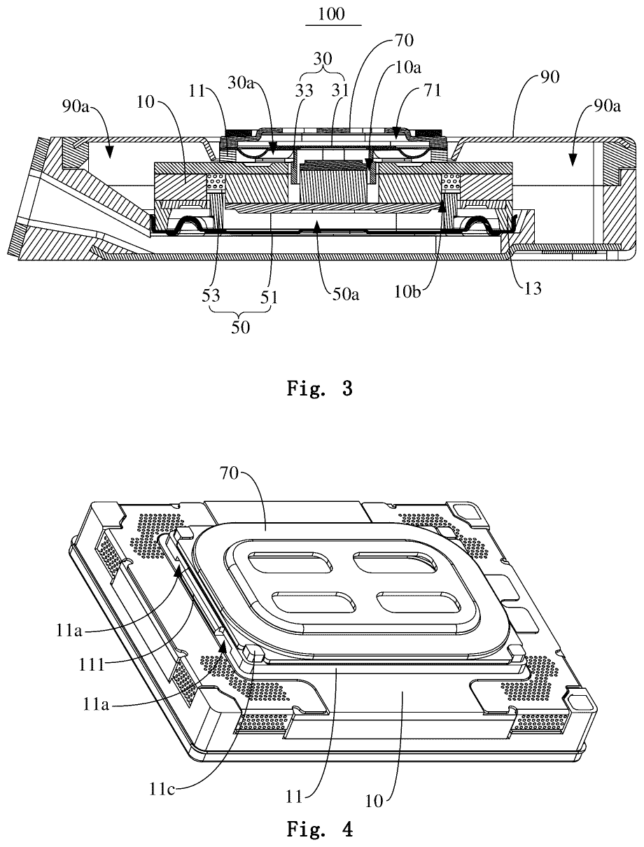

Referring to FIGS. 1 to 5, in an embodiment of the sound production module 100 of the present disclosure, the sound production module 100 includes:
a sound production unit and an expansion cavity 90a, the sound production unit includes a receiver unit 30 and a speaker unit 50 disposed opposite to the receiver unit 30,
the sound production unit further includes a magnetic circuit system 10, a vibration system of the receiver unit 30 and a vibration system of the speaker unit 50 are provided on two opposite sides of the magnetic circuit system 10,
the receiver unit 30 includes a first diaphragm 31, and a first rear cavity 30a is formed between the first diaphragm 31 and the magnetic circuit system 10, the speaker unit 50 includes a second diaphragm 51, and a second rear cavity 50a is formed between the second diaphragm 51 and the magnetic circuit system 10, the first rear cavity 30a and the second rear cavity 50a are separated from each other, and the first rear cavity 30a and the expansion cavity 90a are separated from each other, the receiver unit 30 is provided with a communication hole 11a for communicating the first rear cavity 30a with a space outside the sound production module 100, and the communication hole 11a is not communicated with the expansion cavity 90a.

In the embodiment, when the sound production module 100 is disposed horizontally, the sound production unit, the magnetic circuit system 10 and the receiver unit 30 may be stacked in sequence. At this time, a first magnetic gap 10a is formed on a side of the magnetic circuit system 10 facing the receiver unit 30, and a second magnetic gap 10b is formed on a side of the magnetic circuit system 10 facing the speaker unit 50, and the first magnetic gap 10a and the second magnetic gap 10b are separated from each other.

Specifically, the receiver unit 30 further includes a first voice coil 33 accommodated in the first rear cavity 30a, one end of the first voice coil 33 is connected to the first diaphragm 31, and an opposite end thereof is inserted into the first magnetic gap 10a. In addition, the speaker unit 50 further includes a second voice coil 53 accommodated in the second rear cavity 50a, one end of the second voice coil 53 is connected to the second diaphragm 51, and an opposite end thereof is inserted into the second magnetic gap 10b.

It will be understood that the according to the sound production module 100 of the technical solution of the present disclosure, a receiver unit 30 and a speaker unit 50 are provided, so that the sound production module 100 has dual functions of a receiver function and a speaker function by operating the receiver unit 30 and the speaker unit 50, respectively. Moreover, since the receiver unit 30 and the speaker unit 50 share one magnetic circuit system 10, compared with simply back-to-back stacking of the receiver module and the speaker module, the sound production module 100 in the present solution can reduce the number of magnet systems, which is beneficial to simplify the overall structure of the sound production module 100 and reduce the overall thickness of the sound production module 100, thereby improving its subsequent convenience for installing on the terminal device. Meanwhile, on the basis that the receiver unit 30 and the speaker unit 50 share one magnetic circuit system 10, a first rear cavity 30a may be formed by the first diaphragm 31 of the receiver unit 30 and the magnetic circuit system 10, and the second rear cavity 50a separated from the first rear cavity 30a may be formed by the second diaphragm 51 of the speaker unit 50 and the magnetic circuit system 10. At this time, since the first rear cavity 30a in the receiver unit 30 and the second rear cavity 50a in the speaker unit 50 are in an separated state, the first diaphragm in the receiver unit 30 and the second diaphragm in the speaker unit 50 vibrate only in the first rear cavity 30a and the second rear cavity 50a, respectively, and there will be no problem of airflow interference. This ensures that the receiver unit 30 and the speaker unit 50 can operate normally and stably, respectively, thereby improving the sound production effect of the sound production module 100. Further, the first rear cavity 30a of the receiver unit 30 may be communicated with the space outside the sound production module 100 through a communication hole 11a, thereby providing a sound-enhanced space for the first rear cavity 30a of the receiver unit 30, effectively improving the low-frequency intensity, and further improving the sound production effect of the sound production module 100.

In other words, the sound production module 100 provided in the embodiment has at least the following advantages:

Firstly, in the technical solution of the novel sound production module 100 provided in the embodiment, the receiver unit 30 and the speaker unit 50 share one magnetic circuit system 10, so that compared with simply back-to-back stacking of the receiver module and the speaker module, the sound production module 100 in the present solution can reduce the number of magnet systems, which is beneficial to simplify the overall structure of the sound production module 100 and reduce the overall thickness of the sound production module 100, thereby improving its subsequent convenience for installing on the terminal device.

Secondly, the receiver unit 30 and the speaker unit 50 are designed to be separated, which can better meet the requirements of acoustic devices in different usage scenarios. For example, the stereo effect in the speaker mode can be improved, or two sound waves with opposite phases can be emitted, the two sound waves are cancelled and attenuated based on an acoustic dipole effect, so that the privacy protection effect in the receiver mode can be improved.

Thirdly, according to the technical solution of the novel sound production module 100 provided in the embodiment, the first diaphragm 31 in the receiver unit 30 and the second diaphragm 51 in the speaker unit 50 may vibrate only in the first rear cavity 30a and the second rear cavity 50a, respectively, and there will be no problem of airflow interference. This ensures that the receiver unit 30 and the speaker unit 50 can operate normally and stably, respectively.

Fourthly, according to the technical solution of the novel sound production module 100 provided in the embodiment, by disposing the communication hole 11a communicating the first rear cavity 30a with the space outside the sound production module 100 on the receiver unit 30, a sound-enhanced space may be provided for the first rear cavity 30a of the receiver unit 30, which effectively improving the low-frequency intensity.

Fifthly, according to the technical solution of the novel sound production module 100 provided in the embodiment, it is beneficial to realize a coaxial design of the receiver unit 30 and the speaker unit 50, so that a channel separation phenomenon will not occur, which can improve subjective listening experience.

Furthermore, referring to FIGS. 1 to 3, in an embodiment of the sound production module 100 of the present disclosure, a first frame 11 is provided between the first diaphragm 31 of the receiver unit 30 and the magnetic circuit system 10, and the first frame 11 is provided with the communication hole 11a penetrating through a side wall of the first frame 11.

In the embodiment, the first diaphragm 31 of the receiver unit 30 is fixed on the first frame 11, and the first voice coil 33 of the receiver unit 30 may pass through the first frame 11 and inserted into the first magnetic gap 10a, so that the first frame 11 can be used to ensure the installation stability of the receiver unit 30, to avoid affecting the sound production effect due to position displacement during operation.

In this way, by disposing the communication hole 11a as penetrating through the side wall of the first frame 11, it is possible to prevent the communication hole 11a from being blocked during assembly with a casing 300 and other structures of the terminal device 1000, thereby preventing the communication effect of the communication hole 11a from being affected.

Furthermore, referring to FIGS. 1 to 5, in an embodiment of the sound production module 100 of the present disclosure, a surface of the magnetic circuit system 10 close to the first diaphragm 31 protrudes outward to form the first frame 11, or the first frame 11 and the magnetic circuit system 10 are separated structures. That is, the first frame 11 may be a protruding structure integrally formed with the magnetic circuit system 10 extending to a direction of the first diaphragm 31, to fix the first diaphragm 31. Of course, the first frame 11 may also be provided separately, and by disposing the first frame 11 between the first diaphragm 31 and the magnetic circuit system 10, the first diaphragm 31 may be fixed by the first frame 11.

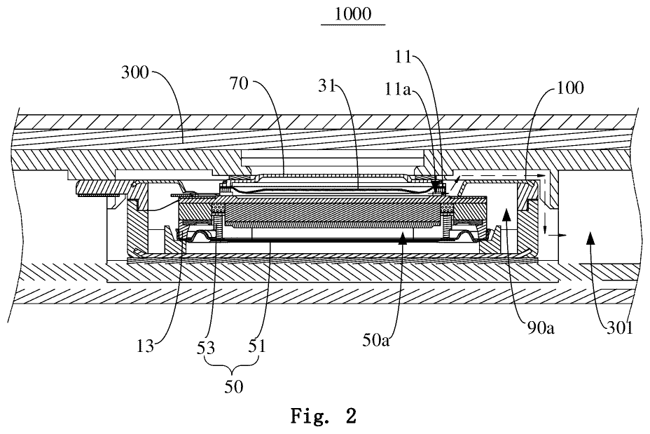

Furthermore, referring to FIG. 2 together, in an embodiment of the sound production module 100 of the present disclosure, a surface of the first frame 11 opposite to the first diaphragm 31 has a groove, and the communication hole 11a is formed between the surface of the first frame 11 having the groove and the magnetic circuit system 10.

In the embodiment, the surface of the first frame 11 opposite to the first diaphragm 31 is inwardly recessed to form the groove, and the groove penetrates from an inner wall of the first frame 11 to an outer wall of the first frame 11.

With such an arrangement, during the preparation process, the groove may be opened or directly formed on a surface of the first frame 11 for installation the magnetic circuit system 10, and after the first frame 11 is installed on the magnetic circuit system 10, the communication hole 11a is formed between the surface of the first frame 11 with the groove and the magnetic circuit system 10, thereby facilitating the formation of the communication hole 11a on the receiver unit 30.

Of course, in another embodiment of the sound production module 100 of the present disclosure, a first frame 11 is provided between the first diaphragm 31 of the receiver unit 30 and the magnetic circuit system 10, a first groove is provided at a position of the magnetic circuit system 10 corresponding to a side wall of the first frame 11, and the communication hole 11a is formed between a surface of the magnetic circuit system 10 having the first groove and the first frame 11.

In the embodiment, the magnetic circuit system 10 may be recessed inwardly at a position corresponding to the side wall of the first frame 11 to form the first groove.

With such an arrangement, during the preparation process, the first groove may be opened or directly formed at a position of the magnetic circuit system 10 for installing the first frame 11, and after the first frame 11 is installed on the magnetic circuit system 10, the communication hole 11a is formed between the surface of the magnetic circuit system 10 having the first groove and the first frame 11. This embodiment can also facilitate the formation of the communication hole 11a on the receiver unit 30.

Of course, in another embodiment of the sound production module 100 of the present disclosure, a first frame 11 is provided between the first diaphragm 31 of the receiver unit 30 and the magnetic circuit system 10, the first frame 11 has a second groove on a surface opposite to the first diaphragm 31, the magnetic circuit system 10 has a third groove at a position corresponding to the first frame 11, and the communication hole 11a is formed between the surface of the first frame 11 having the second groove and a surface of the magnetic circuit system 10 having the third groove.

In the embodiment, the surface of the first frame 11 opposite to the first diaphragm 31 may be inwardly recessed to form the second groove, and the second groove penetrates from an inner wall of the first frame 11 to an outer wall of the first frame 11. Besides, the magnetic circuit system 10 may be recessed inwardly at a position corresponding to the side wall of the first frame 11 to form the third groove.

With such an arrangement, during the preparation process, the second groove may be opened or directly formed on a surface of the first frame 11 for installation the magnetic circuit system 10, and the third groove may be opened or directly formed at a position of the magnetic circuit system 10 for installing the first frame 11. After the first frame 11 is installed on the magnetic circuit system 10, the communication hole 11a is formed between the surface of the first frame 11 having the second groove and the surface of magnetic circuit system 10 having the third groove. This embodiment can also facilitate the formation of the communication hole 11a on the receiver unit 30. Further, in the embodiment, by partially providing the communication hole 11a on the first frame 11 and partially providing the communication hole 11a on the magnetic circuit system 10, the strength of the first frame 11 and the magnetic circuit system 10 themselves can be ensured, thereby preventing the first frame 11 or the magnetic circuit system 10 from being easily deformed when the communication hole 11a is only provided on the first frame 11 or the magnetic circuit system 10.

Furthermore, an embodiment in which the communication hole 11a is disposed on the first frame 11 will be described in detail as an example.

Referring to FIG. 4 together, in an embodiment of the sound production module 100 of the present disclosure, the communication hole 11a is provided on two opposite short axis sides of the first frame 11.

With such an arrangement, when the sound production module 100 is disposed horizontally, since the first diaphragm 31 is supported on the first frame 11, by providing the communication hole 11a on the short axis sides of the first frame 11, the strength of the first frame 11 itself and the bearing capacity for the first diaphragm 31 can be ensured.

Furthermore, referring to FIG. 4 together, in an embodiment of the sound production module 100 of the present disclosure, two communication holes 11a spaced apart are provided on each short axis side of the first frame 11.

With such an arrangement, by providing two communication holes 11a spaced apart on each short axis side of the first frame 11, the first rear cavity 30a can be connected to the space outside the sound production module 100 through the spaced communication holes 11a, to ensure the uniformity of sound wave transmission, thereby further improving the sound production effect.

Furthermore, referring to FIG. 4 together, in an embodiment of the sound production module 100 of the present disclosure, a reinforcing rib 111 is protruded from an outer side wall of the first frame 11, and the reinforcing rib 111 is located between the two communication holes 11a on the same short axis side of the first frame 11.

With such an arrangement, by providing the reinforcement rib 111 on the outer wall of the first frame 11, the strength of the first frame 11 itself and the bearing capacity for the first diaphragm 31 can be improved, to prevent the first frame 11 from being easily deformed due to the provision of the communication hole 11a.

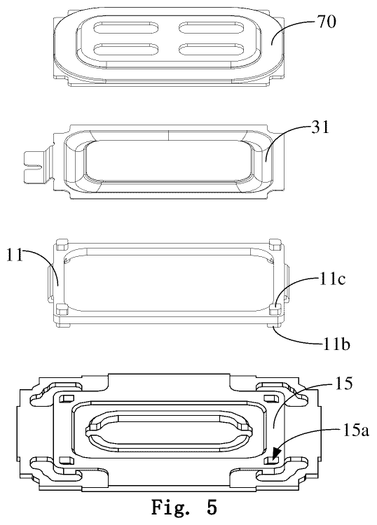

Furthermore, referring to FIG. 5 together, in an embodiment of the sound production module 100 of the present disclosure, a mounting boss 15 is provided on a side of the magnetic circuit system 10 facing the first diaphragm 31, the first frame 11 is provided on the mounting boss 15, and the surface of the first frame 11 having the groove contacts and forms the communication hole 11a with the table surface of the mounting boss 15.

In the embodiment, the first frame 11 may be substantially in a ring-shaped structure to surround the outside of the first voice coil 33.

In this way, by providing the first frame 11 on the table surface of the mounting boss 15 and making the surface of the first frame 11 with the groove contacts and forms a communication hole 11a with the table surface of the mounting boss 15, the installation stability of the first frame 11 on the magnetic circuit system 10 can be ensured.

Furthermore, referring to FIG. 5 together, in an embodiment of the sound production module 100 of the present disclosure, a mounting groove 15a is formed on the table surface of the mounting boss 15, an inserting block 11b protruding the surface of the first frame 11 having the groove is inserted into the mounting groove 15a.

Specifically, a plurality of mounting grooves 15a may be provided, and the plurality of mounting grooves 15a are arranged in sequence and spaced apart along the circumference of the magnetic circuit system 10. Correspondingly, a plurality of inserting blocks 11b may be provided, and the plurality of inserting blocks 11b are arranged in sequence and spaced apart along the circumference of the first frame 11, so that each inserting block 11b is inserted into a mounting groove 15a. Besides, the inserting blocks 11b are spaced apart from the grooves.

With such arrangement, during the assembly process, the inserting block 11b on the first frame 11 may be inserted into the mounting groove 15a of the magnetic circuit system 10, so that the frame and the magnetic circuit system 10 can be quickly installed, and the first frame 11 can be quickly positioned. At the same time, the installation stability of the first frame 11 on the magnetic circuit system 10 may be further ensured.

Furthermore, referring to FIG. 5 together, in an embodiment of the sound production module 100 of the present disclosure, a mounting plane for mounting the first diaphragm 31 is formed on a surface of the first frame 11 opposite to the magnetic circuit system 10.

With such an arrangement, by mounting and fixing the first diaphragm 31 on the mounting plane of the first frame 11, a contact area between the first diaphragm 31 and the first frame 11 can be increased, thereby ensuring the stability of the first diaphragm 31 fixed on the first frame 11.

Furthermore, referring to FIGS. 4 and 5 together, in an embodiment of the sound production module 100 of the present disclosure, a mounting space is formed by a plurality of limit blocks spaced apart protruding from the mounting plane, the first diaphragm 31 is fixed in the mounting space, and the limit blocks are hooked on an edge of the first diaphragm 31.

In the embodiment, the plurality of limit blocks are arranged in sequence and spaced apart along the circumference of the first frame 11 to enclose and form a substantially cubic mounting space.

With such arrangement, during the assembly process, the first diaphragm 31 is directly placed in the mounting space formed by enclosing the plurality of limit blocks, and the limit blocks are hooked on the edge of the first diaphragm 31, so that the first diaphragm 31 can be quickly positioned and mounted, and at the same time, the installation stability of the first diaphragm 31 on the first frame 11 can be further ensured.

Furthermore, referring to FIGS. 4 and 5 together, in an embodiment of the sound production module 100 of the present disclosure, the sound production unit further includes a front cover 70 covered on the first diaphragm 31, an opening is disposed at a position of the front cover 70 directly facing the first diaphragm 31, and the opening forms a first sound outlet channel 71.

Furthermore, referring to FIGS. 1 to 5, in an embodiment of the sound production module 100 of the present disclosure, the magnetic circuit system 10 has a center line extending along a width direction thereof, and the first frame 11 is symmetrically arranged about the center line.

It should be noted that the arrangement direction from one long axis side to the other long axis side of the first frame 11 is defined as a width direction of the first frame 11, and the width direction of the magnetic circuit system 10 is consistent with the width direction of the first frame 11.

In this way, the first frame 11 is symmetrically arranged with respect to the center of the magnetic circuit system 10, so that no additional fool-proof structure is required during assembly, which has the advantage of convenient assembly.

Furthermore, referring to FIG. 4 together, in an embodiment of the sound production module 100 of the present disclosure, a cross-sectional area of the communication hole 11a is defined as S, which satisfies the following condition: 0.5 mm²≤S≤1.0 mm². With such arrangement, if the cross-sectional area of the communication hole 11a is too small, the communicating effect of the communication hole 11a cannot be guaranteed, and if the cross-sectional area of the communication hole 11a is too large, the strength of the first frame 11 is reduced and deformation is more likely to occur.

It should be noted that the cross-sectional area of the communication hole 11a is a cross-sectional area of the communication hole 11a in a direction from the first frame 11 to the magnetic circuit system 10. For example, when the sound production module 100 is placed horizontally, the cross-sectional area of the communication hole 11a is a cross-sectional area of the communication hole 11a in a vertical direction.

Furthermore, referring to FIGS. 1 to 3, in an embodiment of the sound production module 100 of the present disclosure, the sound production module 100 further includes a fix housing 90 for fixing the sound production unit, and the expansion cavity 90a is formed between the fix housing 90 and the sound production unit.

In the embodiment, the first sound outlet channel 71 of the receiver unit 30 is communicated with an external space of the sound production module 100, and the fix housing 90 is provided with an avoidance structure for avoiding the first sound outlet channel 71, so that an external channel is formed between an outer wall of the receiver unit 30 and an inner wall of the avoidance structure, the external channel is separated from an internal space of the fix housing 90, and is communicated with the communication hole 11a and the external space of the sound production module 100. For example, when the sound production module 100 of the present embodiment is applied to the terminal device 1000, the first rear cavity 30a can be connected to the mounting cavity 301 of the casing 300 in the terminal device 1000 through the communication hole 11a and the external channel, to provide a sound-enhanced space for the first rear cavity 30a of the receiver unit 30, thereby effectively improving the low-frequency intensity.

In addition, the fix housing 90 is provided with a second sound outlet channel at a position corresponding to the second diaphragm 71, and an outlet of the second sound outlet channel passes through a peripheral surface of the fix housing 90.

With such an arrangement, by fixing the sound production unit in the fix housing 90, the installation stability of the sound production unit can be ensured, so that the integrity of the sound production module 100 is better and the reliability of the sound production module 100 is higher, and so that the expansion cavity 90a is formed between the fix housing 90 and the sound production unit, a sound-absorbing material can be filled in the expansion cavity 90a to enhance the low frequency of the speaker unit 50.

Moreover, the expansion cavity 90a is separated from the first rear cavity 30a and communicated with the second rear cavity 50a. It should be noted that the expansion cavity 90a is separated from the first rear cavity 30a in the present disclosure means that there is no communication structure in the structure of the sound production module 100 itself that directly communicates the first rear cavity 30a and the expansion cavity 90a.

Typically, a pressure relief hole (or a pressure equalization hole, or a leakage hole) for pressure equalization may be provided on the expansion cavity 90a. The pressure relief hole may guide a part of the airflow in the expansion cavity 90a to the outside/terminal, and the airflow in the first rear cavity 30a may also be directly guided to the outside/terminal. In this case, however, the pressure relief hole is not a communication structure communicating the first rear cavity 30a and the expansion cavity 90a for the following reasons:

1. The technical problem to be solved by the present disclosure is the problem of airflow interference caused when two vibration systems are communicated with the rear cavity. This solution of communicating through the pressure relief hole obviously does not have the problem of airflow interference, it does not belong to the solution of two vibration system being communicated with the rear cavity respectively as described in the Description of Related Art, but belongs to the improved solution of isolating the first rear cavity 30a from the expansion cavity 90a in the present disclosure.

2. The function of the rear cavity pressure relief hole is to equalize the pressure, which is used to achieve micro communication between the air pressure in and outside of the expansion cavity 90a. In order not to affect the listening sensitivity, it is required to bond a damping mesh at a pressure equalizing hole to provide a certain sound resistance. In the present disclosure, the communication hole 11a of the first frame 11 needs to achieve smooth communication between the first rear cavity 30a and the external airflow, and there is no need to provide a damping mesh. It can be seen that the functions of the pressure equalizing hole and the communication hole 11a of the present disclosure are also different.

Furthermore, referring to FIGS. 1 to 3, in an embodiment of the sound production module 100 of the present disclosure, the sound production unit further includes a second frame 13 disposed between the second diaphragm 51 of the speaker unit 50 and the magnetic circuit system 10, the second rear cavity 50a is formed between the second diaphragm 51, the second frame 13 and the magnetic circuit system 10, and the second rear cavity is communicated with the expansion cavity 90a.

With this arrangement, the second diaphragm 51 of the speaker unit 50 is fixed on the second frame 13, and the second voice coil 53 of the speaker unit 50 may penetrate through the second frame 13 and be inserted into the second magnetic gap 10b, so that the installation stability of the speaker unit 50 can be ensured by the second frame 13, to avoid affecting the sound production effect due to position displacement during operation. Besides, by communicating the second rear cavity 50a of the speaker unit 50 to the expansion cavity 90a of the fix housing 90, a sound-enhanced space can be provided to the second rear cavity 50a of the speaker unit 50, thereby effectively improving the low-frequency intensity.

Referring to FIGS. 1 and 2 together, the present disclosure also provides a terminal device 1000 including a casing 300 and the sound production module 100 as described above. The specific structure of the sound production module 100 refers to the above embodiments. The terminal device 1000 adopts all the technical solutions of all the aforementioned embodiments, it at least has all the beneficial effects brought by all the technical solutions of all the aforementioned embodiments, which will not be described here. A mounting cavity 301 is formed in the casing 300. The sound production module 100 is disposed in the mounting cavity 301, and the first rear cavity 30a of the sound production module 100 is communicated with the mounting cavity 301 through a communication hole 11a.

It will be understood that the terminal device 1000 may be but is not limited to a mobile phone, a tablet computer, a television, a monitor, a laptop computer, a digital photo frame, a personal digital assistant (PDA), an e-book reader, an MP3 (Moving Picture Experts Group Audio Layer III) player, an MP4 (Moving Picture Experts Group Audio Layer IV) player, a wearable device, a navigator, a handheld game console, a virtual reality device, an augmented reality device, a desktop speaker, etc.

The above is only preferred embodiments of the present disclosure, and does not limit the patent scope of the present disclosure. All equivalent structural changes made under the inventive concept of the present invention using the contents of the specification and drawings of the present disclosure, or directly/indirectly applications in other related technical fields, are included in the patent protection scope of the present disclosure.

1. A sound production module, wherein the sound production module comprises a sound production unit and an expansion cavity, and the sound production unit comprises a receiver unit and a speaker unit disposed opposite to the receiver unit,
wherein the sound production unit further comprises a magnetic circuit system, a vibration system of the receiver unit and a vibration system of the speaker unit are provided on two opposite sides of the magnetic circuit system,
wherein the receiver unit comprises a first diaphragm, and a first rear cavity is formed between the first diaphragm and the magnetic circuit system,
wherein the speaker unit comprises a second diaphragm, and a second rear cavity is formed between the second diaphragm and the magnetic circuit system,
wherein the first rear cavity and the second rear cavity are separated from each other, and the first rear cavity and the expansion cavity are separated from each other, and
wherein the receiver unit is provided with a communication hole for communicating the first rear cavity with a space outside the sound production module, and the communication hole is not communicated with the expansion cavity.

2. The sound production module of claim 1, wherein a first frame is provided between the first diaphragm of the receiver unit and the magnetic circuit system, and the first frame is provided with the communication hole penetrating through a side wall of the first frame.

3. The sound production module of claim 2, wherein a surface of the first frame opposite to the first diaphragm has a groove, and the communication hole is formed between the surface of the first frame having the groove and the magnetic circuit system, and/or
a surface of the magnetic circuit system close to the first diaphragm protrudes outward to form the first frame, or the first frame and the magnetic circuit system are separated structures.

4. The sound production module of claim 2, wherein the communication hole is provided on two opposite short axis sides of the first frame.

5. The sound production module of claim 4, wherein two communication holes spaced apart are provided on each short axis side of the first frame.

6. The sound production module of claim 5, wherein a reinforcing rib is protruded from an outer side wall of the first frame, and the reinforcing rib is located between the two communication holes on the same short axis side of the first frame.

7. The sound production module of claim 3, wherein a mounting boss is provided on a side of the magnetic circuit system facing the first diaphragm, the first frame is provided on the mounting boss, and the surface of the first frame having the groove contacts and forms the communication hole with a table surface of the mounting boss.

8. The sound production module of claim 7, wherein a mounting groove is formed on the table surface of the mounting boss, an inserting block protruding from the surface of the first frame having the groove is inserted into the mounting groove.

9. The sound production module of claim 8, wherein a mounting plane for mounting the first diaphragm is formed on a surface of the first frame opposite to the magnetic circuit system.

10. The sound production module of claim 9, wherein a mounting space is formed by a plurality of limit blocks spaced apart protruding from the mounting plane, the first diaphragm is fixed in the mounting space, and the limit blocks are hooked on an edge of the first diaphragm.

11. The sound production module of claim 1, wherein a first frame is provided between the first diaphragm of the receiver unit and the magnetic circuit system, a first groove is provided at a position of the magnetic circuit system corresponding to a side wall of the first frame, and the communication hole is formed between a surface of the magnetic circuit system having the first groove and the first frame, or
a first frame is provided between the first diaphragm of the receiver unit and the magnetic circuit system, the first frame has a second groove on a surface opposite to the first diaphragm, the magnetic circuit system has a third groove at a position corresponding to the first frame, and the communication hole is formed between the surface of the first frame having the second groove and a surface of the magnetic circuit system having the third groove.

12. The sound production module of claim 1, wherein the sound production unit further comprises a front cover covered on the first diaphragm, an opening is disposed at a position of the front cover directly facing the first diaphragm, and the opening forms a first sound outlet channel, and/or
the magnetic circuit system has a center line extending along a width direction thereof, and the first frame is symmetrically arranged about the center line, and/or
a cross-sectional area of the communication hole is defined as S, which satisfies the following condition: 0.5 mm²≤S≤1.0 mm².

13. The sound production module of claim 1, wherein the sound production module further comprises a fix housing for fixing the sound production unit, and the expansion cavity is formed between the fix housing and the sound production unit.

14. The sound production module of claim 13, wherein the sound production unit further comprises a second frame disposed between the second diaphragm of the speaker unit and the magnetic circuit system, the second rear cavity is formed between the second diaphragm, the second frame and the magnetic circuit system, and the second rear cavity is communicated with the expansion cavity.

15. A terminal device, comprising:
a casing having a mounting cavity formed therein; and
the sound production module of claim 1 disposed in the mounting cavity, and the first rear cavity of the sound production module is communicated with the mounting cavity through the communication hole.
